(19) United States
(12) Patent Application Publication
(10) Pub. No.: US 2022/0130140 A1
(43) Pub. Date: Apr. 28, 2022

(54) INFORMATION PRESENTATION METHOD, INFORMATION PRESENTATION DEVICE AND PROGRAM

(71) Applicant: NEC corporation, Minato-ku, Tokyo (JP)

(72) Inventors: Soma SHIRAISHI, Tokyo (JP); Yasunori BABAZAKI, Tokyo (JP); Hideaki SATO, Tokyo (JP); Jun PIAO, Tokyo (JP)

(73) Assignee: NEC corporation, Minato-ku, Tokyo (JP)

(21) Appl. No.: 17/436,705

(22) PCT Filed: Mar. 14, 2019
(86) PCT No.: PCT/JP2019/010493

§ 371 Date: Sep. 7, 2021

(51) Int. Cl. G06V 10/778; G06V 10/774

(52) U.S. Cl. CPC G06V 10/7788; G06V 10/774

(57) ABSTRACT

An information presentation device acquires a training image to be used for a learning and acquires an estimated target object position that is a position estimated as an area or coordinates where a target object exists in the training image. Then, information presentation device acquires a specified target object position that is a position specified as the area or the coordinates where the target object exists in the training image and presents information for prompting a user to confirm the area or the coordinates where the target object exists based on a difference between the estimated target object position and the specified target object position.

### TECHNICAL FIELD

The present invention relates to a technical field of an information presentation method, an information presentation device and a program relating to training data used for learning.

### BACKGROUND ART

An example of the method of presenting the information relating to the correction of the correct answer data which indicates the correct answer for learning is disclosed in Patent Literature 1. Patent Literature 1 discloses an approach for displaying a screen view for instructing the deletion or correction of the label to the teacher data, that is the conversion source of the image feature teacher data associated with the target compartment, based on the result of the comparison between the image feature teacher data associated with the target compartment and the image feature teacher data associated with the compartment located in the vicinity thereof.

### PRIOR ART DOCUMENTS

### Patent Literature

Patent Literature 1: JP 2015-185149A

### SUMMARY OF THE INVENTION

### Problem to be Solved by the Invention

Since the correct answer data generated through annotation of the correct answer in the annotation operation is generally adopted as the training data as it is, it is difficult to discover a mistake in the annotation operation or the improper annotation which greatly differs from the standard. When such correct answer data is used for the learning of an estimator as training data, it may cause a decrease in the accuracy of image recognition by the generated estimator. Although Patent Literature 1 describes a method of presenting information instructing correction regarding classification (labels) for an object of interest, it does not disclose anything about presenting information relating to the annotation of the correct answer for the coordinates or areas of the object.

In view of the above-described issues, it is therefore an example object of the present disclosure to provide an information presentation method, an information presentation device, and a program that can appropriately prompt confirmation regarding the position of an object to which the annotation of the correct answer is performed.

### Means for Solving the Problem

In one mode of the information presentation method, there is provided an information presentation method including: acquiring a training image to be used for a learning; acquiring an estimated target object position that is a position estimated as an area or coordinates where a target object exists in the training image; acquiring a specified target object position that is a position specified as the area or the coordinates where the target object exists in the training image; and presenting information for prompting a user to confirm the area or the coordinates where the target object exists based on a difference between the estimated target object position and the specified target object position.

In one mode of the information presentation device, there is provided an information presentation device including: a training image acquisition unit configured to acquire a training image to be used for a learning; an estimated target object position acquisition unit configured to acquire an estimated target object position that is a position estimated as an area or coordinates where a target object exists in the training image; a specified target object position acquisition unit configured to acquire a specified target object position that is a position specified as the area or the coordinates where the target object exists in the training image; and a presentation unit configured to present information for prompting a user to confirm the area or the coordinates where the target object exists based on a difference between the estimated target object position and the specified target object position.

In one mode of the program, there is provided a program executed by a computer, the program causing the computer to function as: a training image acquisition unit configured to acquire a training image to be used for a learning; an estimated target object position acquisition unit configured to acquire an estimated target object position that is a position estimated as an area or coordinates where a target object exists in the training image; a specified target object position acquisition unit configured to acquire a specified target object position that is a position specified as the area or the coordinates where the target object exists in the training image; and a presentation unit configured to present information for prompting a user to confirm the area or the coordinates where the target object exists based on a difference between the estimated target object position and the specified target object position.

### Effect of the Invention

An example advantage according to the present invention is to suitably prompt the confirmation of the position of an object specified in a training image.

### BRIEF DESCRIPTION OF THE DRAWINGS

FIG. 1 illustrates a schematic configuration of an information presentation system in the example embodiment.

FIG. 2 is a functional block diagram of an information presentation device.

FIG. 3A illustrates a display example of a training image which explicitly indicates a specified target object position when a target object is a “person”.

FIG. 3B illustrates a display example of a training image which explicitly indicates an estimated target object position.

FIG. 3C illustrates a display example of a training image which explicitly indicates the specified target object position and the estimated target object position, respectively.

FIG. 4A illustrates a first display example of a confirmation support view before the selection of the target of correction.

FIG. 4B illustrates the first display example of the confirmation support view after the selection of the target of correction.

FIG. 5A illustrates a second display example of the confirmation support view before the selection of the target of correction.

FIG. 5B illustrates the second display example of the confirmation support view after the selection of the target of correction.

FIG. 6 illustrates a third display example of the confirmation support view.

FIG. 7 illustrates a fourth display example of the confirmation support view.

FIG. 8 illustrates a fifth display example of the confirmation support view.

FIG. 9 is a flowchart showing a processing procedure performed by the information presentation device.

FIG. 10 is a functional block diagram of an information presentation device according to a first modification.

FIG. 11 is a flowchart showing a processing procedure performed by the information presentation device according to the first modification.

FIG. 12 illustrates a sixth display example of the confirmation support view.

FIG. 13 is a functional block diagram of the information presentation device according to a fourth modification.

### DESCRIPTION OF EXAMPLE EMBODIMENTS

Hereinafter, an example embodiment of an information presentation method, an information presentation device, and a program will be described with reference to the drawings. Hereafter, the “position” of an object in an image is not limited to a case where it indicates a pixel or sub-pixel corresponding to a representative coordinate of the object, but also includes a case where it refers to a pixel group of an area corresponding to the entire object.

[Overall Configuration]

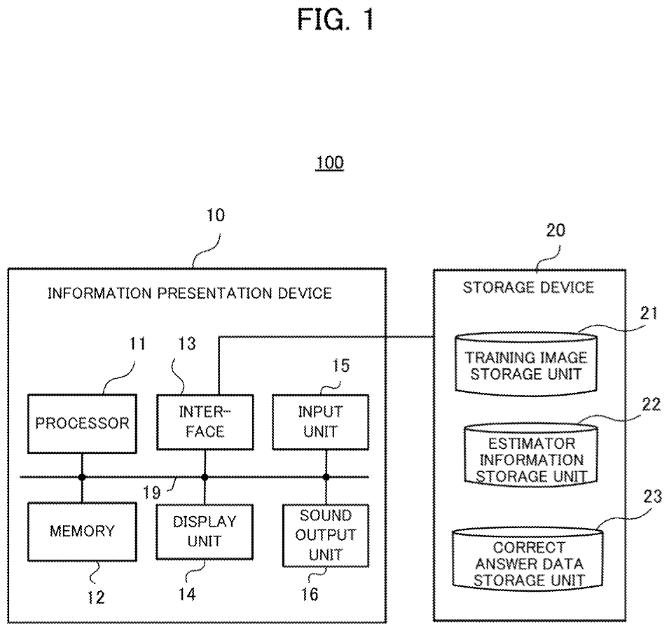

FIG. 1 illustrates a schematic configuration of an information presentation system 100 in the present example embodiment. The information presentation system 100 extracts correct answer data that is likely not correctly annotated by mistake from the correct answer data generated through the manual annotation of the correct answer and thereby suitably prompts the double check and correction relating to the correct answer data. Hereafter, the “training data” is data used for learning and indicates a set (data set) of a training image and correct answer data that indicates the correct output when the corresponding training image is inputted to the learning model.

The information presentation system 100 includes an information presentation device 10 and a storage device 20.

The Information presentation device 10 is an operation device subjected to the operation by a person (also referred to as “confirmer”) which conforms the correct answer data stored in the correct answer data storage unit 23 to be described later. The information presentation device 10 identifies the correct answer data needed to be confirmed among the correct answer data stored in the correct answer data storage unit 23 to be described later, and displays a view (also referred to as “confirmation support view”) prompting confirmation of the correct answer data. Further, the information presentation device 10 accepts an input relating to correction of the correct answer data which is the target of the confirmation, and generates corrected correct answer data (also referred to as “correction data”) that is the correct answer data corrected based on the input. Then, the information presentation device 10 updates the correct answer data storage unit 23 by the generated correction data.

The storage device 20 is a device in which the information presentation device 10 can refer to and write data, and includes a training image storage unit 21, an estimator information storage unit 22, and a correct answer data storage unit 23.

The training image storage unit 21 stores a training image group that is a plurality of training images. Each training image contains an object (also referred to as “target object”) subjected to annotation of the correct answer. The target object is a particular object or a particular part of the object, and examples of the target object include an animal such as a person or a fish, a plant, a moving object, a feature, an instrument or a part thereof. For example, a person is displayed in a training image used for a learning model for extracting a human area.

The estimator information storage unit 22 stores various information necessary to function the estimator. Here, the estimator is a learning model learned to output, from an input image, an estimation result regarding the coordinates or areas of a target object existing in the input image. In this case, the learning model may be a learning model based on a neural network, or may be other types of learning models such as a support vector machine. For example, when the learning model is a neural network such as a convolutional neural network, the estimator information storage unit 22 includes various information necessary to configure an estimator such as, for example, a layer structure, a neuron structure of each layer, the number of filters and filter sizes in each layer, and the weights of each element of each filter.

The correct answer data storage unit 23 stores correct answer data corresponding to the training image stored in the training image storage unit 21. Here, the correct answer data includes classification information indicating the classification (type) of the target object which appears in the corresponding training image, and information indicating the area or coordinates of the target object. In the case where only one type of the target object is present, the correct answer data may not include the classification information described above. The area or the coordinates of the target object is the area or the coordinates of the target object specified based on the annotation operation that is a manual operation for specifying the correct answer and is hereinafter also referred to as “specified target object position Ps”. The specified target object position Ps is not limited to the area or the coordinates of the target object directly specified by the annotation operation, and it may be an area or coordinates corrected from the area or the coordinates specified by the annotation operation by a predetermined correction algorithm.

[Hardware Configuration]

Next, a hardware configuration of the information presentation device 10 will be described with reference to FIG. 1. The information presentation device 10 includes, as hardware, a processor 11, a memory 12, an interface 13, a display unit 14, an input unit 15 and a sound output unit 16. The processor 11, the memory 12 and the interface 13 are connected via a data bus 19.

The processor 11 executes a predetermined process by executing a program stored in the memory 12. The processor 11 is a processor such as a CPU (Central Processing Unit) or a GPU (Graphics Processing Unit).

The memory 12 is composed of various memories such as a RAM (Random Access Memory), a ROM (Read Only Memory), and a flash memory. In addition, a program for executing a process relating to learning executed by the information presentation device 10 is stored in the memory 12. The memory 12 is used as a work memory and temporarily stores information acquired from the storage device 20. The memory 12 may function as a storage device 20. In this case, the memory 12 stores the training image storage unit 21, the estimator information storage unit 22, and the correct answer data storage unit 23. In contrast, the storage device 20 may function as a memory 12 of the information presentation device 10. The program executed by the information presentation device 10 may be stored in a storage medium other than the memory 12.

The interface 13 is a communication interface for wired or wireless transmission and reception of data to and from the storage device 20 under the control of the processor 11, and includes a network adapter and the like. The information presentation device 10 and the storage device 20 may be connected by a cable or the like. In this case, the interface 13 is a communication interface for exchanging data with the storage device 20 or an interface that conforms to a USB, a SATA (Serial AT Attachment) and the like for performing data communication with the storage device 20.

The display unit 14 is a display or the like, and displays a confirmation support view or the like based on the control of the processor 11. The input unit 15 is an input device such as a mouse, a keyboard, a touch panel, or a voice input device, and receives input relating to re-designation of coordinates or areas of the target object in the training image displayed on the display unit 14. The sound output unit 16 is a speaker or the like for outputting sound based on the control of the processor 11. Under the control by the processor 11, for example, the sound output unit 16 outputs a voice guidance or the like for supporting the confirmation on the confirmation support view.

[Functional Block]

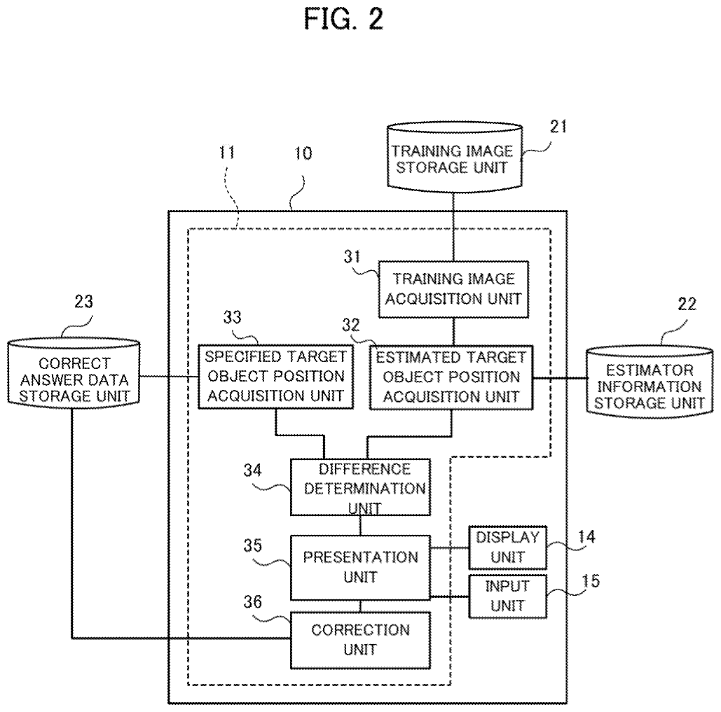

FIG. 2 is a functional block diagram of the information presentation device 10. As shown in FIG. 2, the processor 11 of the information presentation device 10 functionally includes a training image acquisition unit 31, an estimated target object position acquisition unit 32, a specified target object position acquisition unit 33, a difference determination unit 34, a presentation unit 35 and a correction unit 36.

The training image acquisition unit 31 acquires, from the training image storage unit 21, a training image subjected to determination of the necessity of the confirmation by the confirmer. It is noted that the training image acquisition unit 31 may acquire a plurality of training images collectively from the training image storage unit 21 or may acquire one training image from the training image storage unit 21. In the former case, the information presentation device 10 executes subsequent processing on the acquired plurality of training images, and in the latter case, the information presentation device 10 executes subsequent processing on the acquired one training image and repeatedly executes the processing on the other training images.

The estimated target object position acquisition unit 32 inputs the training image acquired by the training image acquisition unit 31 to the estimator configured with reference to the estimator information storage unit 22, and acquires the estimation result relating to the area or the coordinates of the target object displayed on the inputted training image. Hereafter, the area or the coordinates of the estimated object outputted by the estimator is also referred to as the “estimated target object position Pe”. It is noted that a plurality of the estimated target object positions Pe may exist in a single training image, or no estimated target object positions Pe may exist in the training image. Then, the estimated target object position acquisition unit 32 supplies the information indicative of the estimated target object position Pe acquired by the estimator to the difference determination unit 34.

The specified target object position acquisition unit 33 extracts correct answer data corresponding to the training image acquired by the training image acquisition unit 31 from the correct answer data storage unit 23. Here, the correct answer data extracted by the specified target object position acquisition unit 33 includes a specified target object position Ps specified by the annotation operation of the correct answer for the target object displayed on the training image acquired by the training image acquisition unit 31. It is noted that multiple specified target object positions Ps may exist in a single training image or no specified target object position Ps may exist in the training image. Then, the specified target object position acquisition unit 33 supplies the information indicative of the specified target object position Ps included in the correct answer data extracted from the correct answer data storage unit 23 to the difference determination unit 34.

The difference determination unit 34 determines the correspondence between the estimated target object position Pe supplied from the estimated target object position acquisition unit 32 and the specified target object position Ps supplied from the specified target object position acquisition unit 33, and calculates the difference (also referred to as “object position difference dP”) between the estimated target object position Pe and the corresponding specified target object position Ps. Specific examples of the index to be calculated as the target object position difference dP will be described later. Then, if the calculated object position difference dP is equal to or larger than a predetermined threshold value (also referred to as “threshold dPth”), the difference determination unit 34 regards the target object position indicated by the corresponding estimated target object position Pe and the specified target object position Ps as the target object position (also referred to as “confirmation-needed target object position Ptag”) needed to be confirmed. When detecting the target object position Ptag, the difference determination unit 34 supplies a combination of the target training image and a pair of the estimated target object position Pe and and the specified target object position Ps to the presentation unit 35.

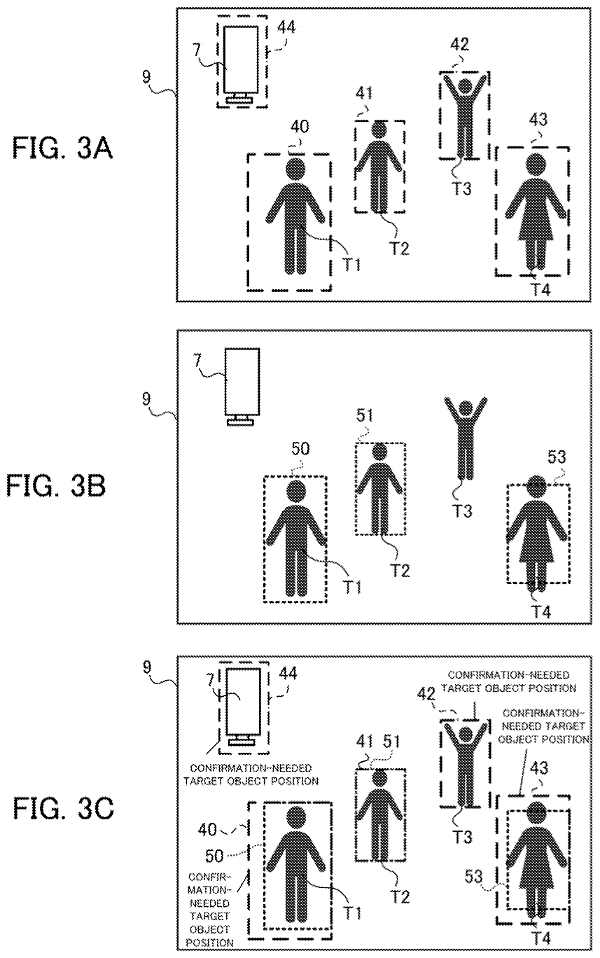

Further, the difference determination unit 34 also regards the specified target object position Ps that has no correspondence to (cannot be associated with) the estimated target object position Pe, and the estimated target object position Pe that has no correspondence to (cannot be associated with) the specified target object position Ps as the target object position difference dP equal to or larger than the threshold value dPth, and regards the target object positions indicated by them as the confirmation-needed target object position Ptag. Therefore, in this case, the difference determination unit 34 supplies the estimated target object positions Pe or the specified target object positions Ps and the target training image to the presentation unit 35. A detailed description will be given of the process by the difference determination unit 34 with reference to FIG. 3.

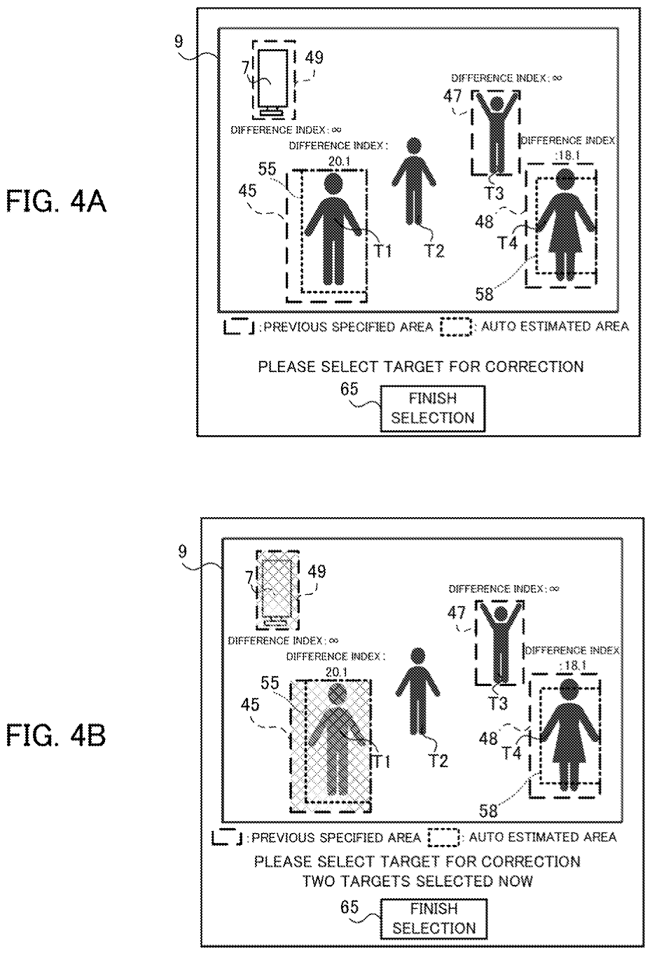

The presentation unit 35 displays the confirmation support view on the display unit 14 based on the training image of the target object and at least one of the estimated target object position Pe and the specified target object position Ps which are received from the difference determination unit 34. The confirmation support view will be described later with reference to FIGS. 4 to 8. Further, the presentation unit 35 supplies the correction unit 36 with the input information relating to the correction of the correct answer data which the confirmer inputs on the confirmation support view by the input unit 15. The input information described above includes information relating to the target object position re-specified by the confirmer as a correct answer, or information which instructs the deletion of the specified target object position Pe.

The correction unit 36 generates, on the basis of the input information supplied from the presentation unit 35, the correction data that is the corrected answer data and updates the correct answer data storage unit 23 by the generated correction data. Thereby, the correction unit 36 suitably updates the correct answer data corresponding to the target object position to be determined by the confirmer that the correction is required among the confirmation-needed target object positions Ptag.

[Calculation of Target Object Position Difference]

Next, a description will be given of a calculation method of the target object position difference dP by the difference determination unit 34. First, an outline of the calculation method of the target object position difference dP will be described with reference to FIGS. 3A to 3C.

FIG. 3A is a display example of a training image 9 that explicitly indicates a specified target object positions Ps when the type of the target object is a “person”. FIG. 3B is a display example of a training image 9 which explicitly indicates the estimated target object positions Pe. FIG. 3C is a display example of a training image 9 that explicitly indicates the specified target object positions Ps of FIG. 3A and the estimated target object positions Pe of FIG. 3B, respectively. Here, in the training image 9, there are target objects “T1” to “T4” each of which is a person, and there is a signboard 7 which is an object that is not the target object.

Here, as shown in FIG. 3A, the specified target object positions Ps indicated by the frames 40 to 43 are determined to the training image 9 for the target objects T1 to T4, respectively. On the other hand, the specified target object position Ps indicated by the frame 44 is determined in the training image 9 with respect to the signboard 7 that is not the target object. In contrast, as shown in FIG. 3B, with respect to the target objects T1, T2, T4, the estimated target object positions Pe indicated by the frames 50, 51, 53 are respectively determined in the training image 9. Since the detection leakage of the target object T3 by the estimator has occurred, the estimated target object position Pe is not set for the target object T3.

In this case, first, the difference determination unit 34 recognizes the correspondence between the respective specified target object positions Ps and the estimated target object positions Pe. In this case, on the basis of the correspondence determination method described later, the difference determination unit 34 recognizes that the estimated target object position Pe indicated by the frame 50 corresponds to the specified target object position Ps indicated by the frame 40, the estimated target object position Pe indicated by the frame 51 corresponds to the specified target object position Ps indicated by the frame 41, and the estimated target object position Pe indicated by the frame 53 corresponds to the specified target object position Ps indicated by the frame 43, respectively. Further, the difference determination unit 34 recognizes that there is no estimated target object position Pe which corresponds to the specified target object position Ps indicated by the frame 42 or the specified target object position Ps indicated by the frame 44.

Next, the difference determination unit 34 calculates the target object position difference dP between the specified target object position Ps and the corresponding estimated target object position Pe. Specific examples of the index to be calculated as the target object position difference dP will be described later. Then, in this case, the difference determination unit 34 determines that the target object position difference dP between the estimated target object position Pe indicated by the frame 50 and the specified target object position Ps indicated by the frame 40 is equal to or larger than the threshold dPth and therefore regards the target object position corresponding to the target object T1 as the confirmation-needed target object position Ptag. In the same way, the difference determination unit 34 determines that the target object position difference dP between the estimated target object position Pe indicated by the frame 53 and the specified target object position Ps indicated by the frame 43 is equal to or larger than the threshold dPth, and therefore regards the target object position corresponding to the target object T4 as the confirmation-needed target object position Ptag.

Further, since there is no estimated target object position Pe which corresponds to the specified target object position Ps indicated by the frame 42, the difference determination unit 34 determines that the target object position difference dP with respect to the specified target object position Ps indicated by the frame 42 is equal to or larger than the threshold dPth. Then, the difference determination unit 34 regards the target object position corresponding to the target object T3 also as the confirmation-needed target object position Ptag. In the same way, since there is no estimated target object position Pe which corresponds to the specified target object position Ps indicated by the frame 44, the difference determination unit 34 also regards the target object position corresponding to the signboard 7 as the confirmation-needed target object position Ptag. On the other hand, the difference determination unit 34 determines that the target object position difference dP between the estimated target object position Pe indicated by the frame 51 and the specified target object position Ps indicated by the frame 41 is smaller than the threshold dPth, and therefore determines that the target object T3 is not the confirmation-needed target object position Ptag.

Thus, on the basis of the target object position difference dP between the specified target object position Ps and the estimated target object position Pe, the difference determination unit 34 can suitably select the confirmation-needed target object position Ptag that is a target requiring double confirmation.

Next, a method for determining the correspondence between the specified target object position Ps and the estimated target object position Pe will be specifically described.

As a first correspondence determination method, first, the difference determination unit 34 calculates the target object position difference dP of every estimated target object position Pe for each specified target object position Ps, respectively. The calculation method of the target object position difference dP will be described later. Then, for each of the specified target object position Ps, the difference determination unit 34 regards, as the corresponding estimated target object position Pe, an estimated target object position Pe whose object position difference dP is the minimum among all estimated target object positions Pe and smaller than a predetermined threshold value (also referred to as “second threshold value”). Then, the difference determination unit 34 associates each specified target object position Ps with the corresponding estimated target object position Pe. The second threshold value is set to be a value larger (i.e., a value that becomes a looser criterion) than the threshold dPth.

For example, when the training image 9 shown in FIGS. 3A to 3C is taken as an example, the difference determination unit 34 calculates the target object position difference dP between the estimated target object positions Pe indicated by the frames 50, 51, and 53 for each of the specified target object positions Ps indicated by the frames 40 to 44. Then, the difference determination unit 34 associates each specified target object position Ps with the estimated target object position Pe with the minimum object position difference dP that is smaller than the second threshold value. In this case, for each of the specified target object positions Ps indicated by the frame 40, 41, 43, the difference determination unit 34 determines that there is an estimated target object position Pe (here, estimated target object position Pe indicated by each of the frames 50, 51 and 53) corresponding to the minimum object position difference dP that is smaller than the second threshold value. On the other hand, for the specified target object positions Ps indicated by the frame 42 and the frame 44, the difference determination unit 34 determines that there is no estimated target object position Pe corresponding to the minimum object position difference dP that is smaller than the second threshold.

In the first correspondence determination method described above, there is a possibility that the overlap occurs in the correspondence relation. To prevent this, for example, the following second correspondence determination method may be performed.

In the second correspondence determination method, as a first step, the difference determination unit 34 calculates the target object position differences dP corresponding to all estimated target object positions Pe for each of the specified target object position Ps, respectively. Then, the difference determination unit 34 holds the list of all the calculated object position differences dP as a first list. Each item constituting the first list is associated with the target object position difference dP and a combination of the corresponding specified target object position Ps and the estimated target object position Pe. As a second step, the difference determination unit 34 performs sorting the items of the first list in ascending order (i.e., in order from the smallest object position difference dP). As a third step, the difference determination unit 34 regards, as the combination with the corresponding relation, the combination of the specified target object position Ps and the estimated target object position Pe corresponding to the item (i.e., the top item in the list) with the smallest target object position difference dP. Then, the difference determination unit 34 removes items related to at least one of the above-mentioned specified target object position Ps or the above-mentioned estimated target object position Pe from the first list. Then, the difference determination unit 34 repeatedly executes the first to third steps until there are no items in the first list or until there is no object position difference dP that is smaller than the second threshold value.

Next, a specific example of the index used as the target object position difference dP will be described below.

First, a case will be described in which a rectangular area is specified as the specified target object position Ps and the estimated target object position Pe. In this case, in the first example, the difference determination unit 34 calculates the difference between the coordinates of the four corners (i.e., upper left vertex, lower left vertex, upper right vertex, lower right vertex) of the rectangular areas each indicated by the specified target object position Ps and the estimated target object position Pe as the target object position difference dP. The difference in this case is, for example, the squared error, the absolute error or the maximum error of the two-dimensional coordinate values on the image. Incidentally, the difference determination unit 34 may calculate the total value of the difference calculated respectively for the four points as the target object position difference dP or may calculate a representative value such as an average value for the difference for the four points as the target object position difference dP.

In the second example in the case where the rectangular area is specified as the specified target object position Ps, the difference determination unit 34 calculates, as the target object position difference dP, the difference regarding the representative coordinates, height and width between the rectangular areas indicated by the specified target object position Ps and the rectangular areas indicated by the estimated target object position Pe.

In the third example in the case that the rectangular area is specified as the specified target object position Ps, the difference determination unit 34 calculate, as the target object position difference dP, the IoU (Intersection over Union) between the rectangular area indicated by the specified target object position Ps and the rectangular area indicated by the estimated target object position Pe. Namely, in this case, the difference determination unit 34 calculates, as the target object position difference dP, the ratio of the overlapping area between the rectangular area indicated by the specified target object position Ps and the rectangular area indicated by the estimated target object position Pe to the union area between the rectangular area indicated by the specified target object position Ps and the rectangular area indicated by the estimated target object position Pe.

Further, when an area other than a rectangular area is specified as the specified target object position Ps and the estimated target object position Pe, for example, the difference determination unit 34 calculates, as the target object position difference dP, the IoU between the area indicated by the specified target object position Ps and the area indicated by the estimated target object position Pe.

When the training image is a three-dimensional image, for example, a rectangular parallelepiped is specified as the specified target object position Ps, and the difference determination unit 34 calculates, as the target object position difference dP, the difference regarding all vertices (8 points) between the rectangular parallelepiped indicated by the estimated target object position Pe and the rectangular parallelepiped indicated by the specified target object position Ps. In another example, the difference determination unit 34 may calculate the IoU between the solid indicated by the specified target object position Ps and the solid indicated by the estimated target object position Pe as the target object position difference dP.

Next, a case where the coordinates are specified as the specified target object position Ps and the estimated target object position Pe will be described. In this case, the difference determination unit 34 calculates the error between the coordinates indicated by the specified target object position Ps and the coordinates indicated by the estimated target object position Pe as the target object position difference dP. The error in this case may be a squared error, or may be an absolute error, or may be the largest error or may be an error based on OKS (Object Keypoint Similarity).

In addition, when a plurality of feature points serving as the target object to be extracted exists in the same object, the difference determination unit 34 may calculate the total value or the maximum error of the errors for feature points (e.g., the feature point of the face, the joint point of the body) as the target object position difference dP.

[Display of Confirmation Support View]

Next, a process relating to the display of the confirmation support view will be described.

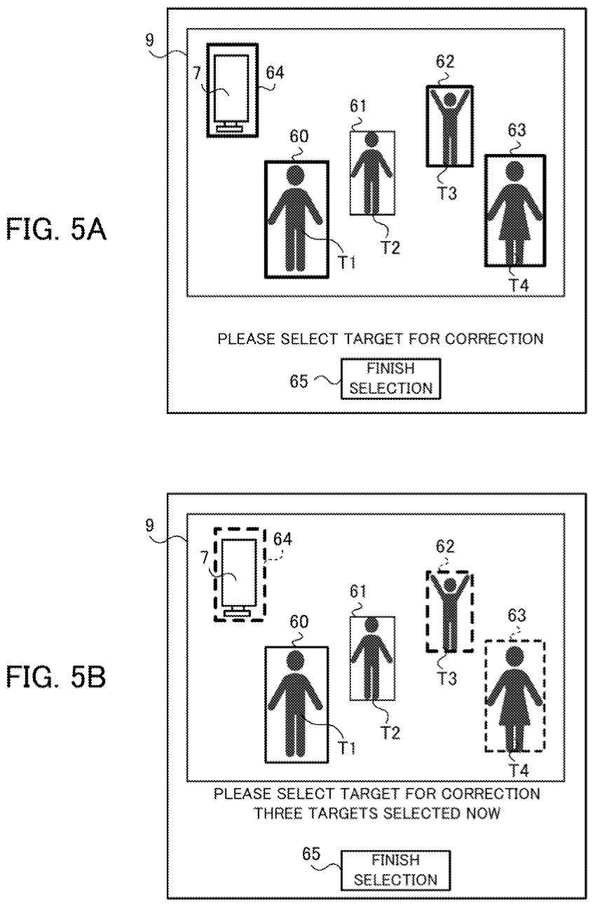

First, a description will be given with reference to FIGS. 4A and 4B and FIGS. 5A and 5B of the display example when the information presentation device 10 displays a screen view as the confirmation support view for allowing the user to select the target object position to be corrected.

FIG. 4A illustrates a first display example of the confirmation support view which the presentation unit 35 displays on the display unit 14. In FIG. 4A, the presentation unit 35 mainly displays, on the confirmation support view, a training image 9 which explicitly indicates the specified target object position Ps and the estimated target object position Pe shown in FIG. 3C and a selection finish button 65.

In FIG. 4A, the presentation unit 35 considers the target object positions corresponding to the target objects T1, T3 and T4, and the signboard 7 as the confirmation-needed target object position Ptag based on the information supplied from the difference determination unit 34, and highlights these object positions by the broken line frames in a state where each position is selectable. Here, as an example, the presentation unit 35 displays the specified target object positions Ps (“PREVIOUS SPECIFIED AREA” in the drawing) by using the frames 45, 47 to 49 that are at the same positions as the frames 40 and 42 to 44 in FIG. 3C. Further, the presentation unit 35 displays the estimated target object position Pe (“AUTO ESTIMATED AREA” in the drawing) by the frames 55 and 58 which are the same positions as the frames 50 and 53 in FIG. 3C. In addition, the presentation unit 35 displays the target object position difference dP calculated by the difference determination unit 34 as the “DIFFERENCE INDEX” with respect to each target object area serving as the confirmation-needed target object position Ptag. For the target object position of the target object T2 which is not the confirmation-needed target object position Ptag, the presentation unit 35 does not perform the highlighted display by broken line nor display based on the target object position difference dP.

When detecting that an area in the broken line frame is selected by a click, a tap operation or the like, the presentation unit 35 displays the selected area in the frame in a manner that is distinguishable from unselected areas in the frames.

FIG. 4B illustrates a state in which the two target object positions are selected in the first display example shown in FIG. 4A. In this case, the presentation unit 35 detects that the frame 49 indicating the target object position of the signboard 7 is selected and highlights it by hatching the frame 49. In the same way, the presentation unit 35 detects that the frame 45 indicating the target object position of the target object T1 is selected and highlights it by hatching the frame 45. Instead of highlighting the area within the selected frame by hatching, the presentation unit 35 may emphasize it by changing the color or blinking of the selected broken line frame.

Then, when detecting that the selection finish button 65 is selected, the presentation unit 35 determines that the correction relating to the specified target object position Ps that is the target object position in the selected frame is necessary. Then, the presentation unit 35 switches the view to another confirmation support view for performing the correction. The confirmation support view in this case will be described later as a third display example and a fourth display example of the confirmation support view.

FIG. 5A illustrates a second display example of the confirmation support view. In FIG. 5A, the presentation unit 35 displays, in a selectable state, all target object positions by the frames 60 to 64 for which the target object position difference dP is calculated. Further, the presentation unit 35 displays the frames (here, the frames 60, 62 to 64) corresponding to the confirmation-needed target object position Ptag so that the frames are prominent than the other frame (here, the frame 61). It is noted that the presentation unit 35 may highlight the confirmation-needed target object position Ptag by not only using the thicker frame but also hatching the frame, setting the color of the frame to a conspicuous color or by other various method.

In the second display example, the presentation unit 35 displays the frames 60 to 64 based on at least one of the corresponding specified target object position Ps or the estimated target object position Pe. For the frames 60, 61 and 63 corresponding to the target object position where a combination of the corresponding specified target object position Ps and estimated target object position Pe exists, as a first example, the presentation unit 35 displays the frame surrounding either the specified target object position Ps or the estimated target object position Pe. As a second example, the presentation unit 35 calculates the average area obtained by averaging each combination of the corresponding specified target object position Ps and estimated target object position Pe and displays the frame surrounding the average area as each of the frames 60, 61 and 63 described above. The average area described above, for example, is calculated by averaging the coordinates of the four vertices of the specified target object position Ps and the estimated target object position Pe, respectively.

On the other hand, as the frames 62 and 64 for the target object position where the combination of the corresponding specified target object position Ps and estimated target object position Pe does not exist, the presentation unit 35 displays frames each surrounding the specified target object position Ps or the estimated target object position Pe (here, the specified target object position Ps) that exists.

FIG. 5B illustrates a state in which frames 62 to 64 corresponding to three object positions are selected in the second display example shown in FIG. 5A. In this case, the presentation unit 35 detects that the frame 64 corresponding to the signboard 7 has been selected and changes the frame 64 to a broken line. Similarly, the presentation unit 35 detects that the frame 62 and the frame 63 corresponding to the target objects T3 and T4 are selected, and changes each of the frame 62 and the frame 63 to a broken line.

Thus, according to the first display example and the second display example of the confirmation support view, the presentation unit 35 suitably highlights the confirmation-needed target object position Ptag by frame, and can display the confirmation-needed target object position Ptag in a selectable way so that the confirmer can specify the confirmation-needed target object position Ptag as a correction target.

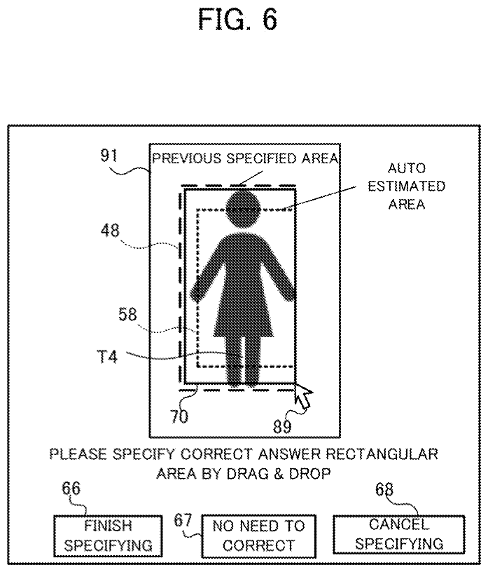

Next, a description will be given with reference to FIGS. 6 to 8 of a display example of a confirmation support view that accepts an input of re-designation for the target object position subjected to correction.

FIG. 6 is a third display example of the confirmation support view. For example, the presentation unit 35 displays the confirmation support view shown in FIG. 6 for each of the target object positions selected in the confirmation support view according to the first display example or the second display example described above.

In the example of FIG. 6, the presentation unit 35 displays a cut-out image 91, a specifying finish button 66, a correction no-need button 67, and a specifying cancel button 68. Here, the cut-out image 91 is cut out from the training image 9 so as to include at least the specified target object position Ps and the estimated target object position Pe indicating the target object position of the target object T4 selected as the correction target in the confirmation support view shown in FIGS. 4A to 5B. If there is no correspondence between the specified target object position Ps and the estimated target object position Pe, the cut-out image 91 is cut out from the training image 9 so as to include either one of the existing specified target object position Ps or the existing estimated target object position Pe. Further, in the example of FIG. 6, the presentation unit 35 displays, on the cut-out image 91, a frame 48 indicating the specified target object position Ps, a frame 58 indicating the estimated target object position Pe and a frame 70 indicating the corrected specified target object position Ps (also referred to as “corrected specified target object position Ps.”). The frame 48 and the frame 58 each is an example of a graphic showing a guide for correcting the specified target object position Ps.

Here, it is possible to specify the corrected specified target object position Ps on the cut-out image 91 in the confirmation support view shown in FIG. 6. In the confirmation support view, the presentation unit 35 displays “Please specify the correct answer rectangular area by drag and drop” as characters indicating a guide for correcting the specified target object position Ps. Here, the presenting unit 35 detects a drag-and-drop operation performed by the cursor 89 of the mouse, and displays by the frame 70 a rectangular area whose vertices in the diagonal are the position of the start of the drag operation and the position of the drop operation. Then, the presentation unit 35 recognizes the frame 70 as a corrected specified target object position Ps. It is noted that, if the closed area is specified by a drag operation by a mouse and the like, the presentation unit 35 may recognize the specified closed area as a corrected specified target object position Ps.

Then, when detecting that the specifying finish button 66 is selected, the presentation unit 35 supplies information relating to the corrected specified target object position Ps displayed on the confirmation support view to the correction unit 36. In this case, on the basis of the information relating to the corrected specified target object position Ps supplied from the presentation unit 35, the correction unit 36 generates correction data that is corrected correct answer data for the training image 9 and updates the correct answer data storage unit 23 by the correction data.

A description will be given of a case where the confirmation support view relating to the target object position corresponding to only the estimated target object position Pe is displayed and where the specified target object position Ps is not generated correctly due to oversight or the like in the annotation operation of the correct answer. In this case as well, in the same manner as in the example of FIG. 6, the presentation unit 35 receives an input for specifying the target object position on the confirmation support view. Then, when detecting the selection of the specifying finish button 66, the presentation unit 35 supplies information indicating the specified target object position to the correction unit 36. In this case, the correction unit 36 regards the target object position supplied from the presentation unit 35 as the specified target object position Ps with respect to the target object. Then, the presentation unit 35 generates correction data in which the information indicative of the target object position is added to the correct answer data. Then, the correction unit 36 updates the correct answer data storage unit 23 by the correction data. Thereby, the information indicative of the specified target object position Ps for the target object which has been overlooked in the first annotation operation of the correct answer is suitably added to the correct answer data.

Further, when detecting that the correction no-need button 67 is selected, the presentation unit 35 determines that there is no need to correct the specified target object position Ps with respect to the target object position and does not performs the process of generating a corrected specified target object position Ps. It is noted that in a case where the confirmation support view relating to the target object position only corresponding to the estimated target object position Pe is displayed and where the estimated target object position Pe is generated due to the fact that the estimator incorrectly detects another object, the confirmer selects the correction no-need button 67 without performing the area designation.

Further, when detecting that the specifying cancel button 68 is selected, the presentation unit 35 determines that the specified target object position Ps is accidentally attached to an object that is not the target object, and supplies information indicative of instructions to delete the specified target object position Ps to the correction unit 36. In this case, the correction unit 36 generates correction data in which the information indicative of the target specified target object position Ps is deleted from the correct answer data for the training image 9.

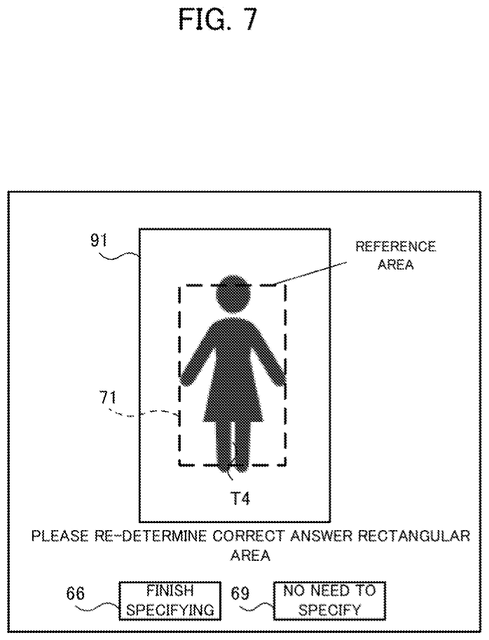

FIG. 7 is a fourth display example of the confirmation support view. In the example of FIG. 7, the presentation unit 35 displays the cut-out image 91, the specifying finish button 66, and the specifying no-need button 69 on the confirmation support view.

The presentation unit 35 displays on the cut-out image 91 the frame 71 indicative of a reference area in order to support the operation in which the confirmer specifies the corrected specified target object position Ps. In this case, for example, the presentation unit 35 calculates an average area obtained by averaging the corresponding specified target object position Ps and estimated target object position Pe, and then displays a frame surrounding the average area as the frame 71 described above. Then, in the same way as the first display example of the confirmation support view shown in FIG. 6, when there is an input for specifying corrected specified target object position Ps, the presentation unit 35 displays a frame indicating the corrected specified target object position Ps. Then, when detecting that the specifying finish button 66 is selected, the presentation unit 35 supplies information relating to the corrected specified target object position Ps displayed on the confirmation support view to the correction unit 36. The frame 71 is an example of a graphic showing a guide for correcting the specified target object position Ps.

Further, when detecting that the specifying no-need button 69 is selected, the presentation unit 35 notifies, without generating information indicative of the corrected specified target object position Ps, the correction unit 36 that the specified target object position Ps with respect to the target object position is not necessary. In this case, when the specified target object position Ps relating to the target object position is recorded in the correct answer data corresponding to the training image 9, the correction unit 36 generates the correction data in which information indicative of the specified target object position Ps is deleted from the correct answer data.

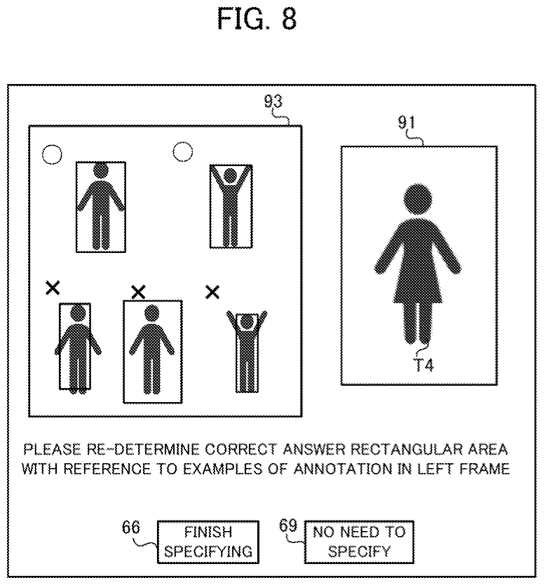

FIG. 8 is a fifth display example of the confirmation support view. In the example of FIG. 8, the presentation unit 35 displays a cut-out image 91, an annotation example image 93, a specifying finish button 66, and a specifying no-need button 69 on the confirmation support view.

The annotation example image 93 is an image showing appropriate setting examples (upper two examples) of the target object position with respect to the target object of the interest and setting examples (lower three examples) of failure likely to occur in the setting of the target object position with respect to the target object of the interest. The annotation example image 93 is stored for each type of the target object in the memory 12 or the storage device 20 of the information presentation device 10, for example. Then, when displaying the confirmation support view of FIG. 8, the presentation unit 35 acquires the annotation example image 93 corresponding to the type of the target object from the memory 12 or the storage device 20, and displays the annotation example image 93 on the confirmation support view. The annotation example image 93 is an example of a character or graphic showing a guide for correcting the specified target object position Ps.

Thus, according to the fifth display example, the presentation unit 35 displays the annotation example image 93 on the confirmation support view together with the cut-out image 91. Thereby, it is possible to suitably support the designation operation of the target object position by the confirmer.

The presentation unit 35 may display the confirmation support view according to the third to fifth display examples after the selection of the correction target on the confirmation support view according to the first to second display examples or and may display the confirmation support view according to the third to fifth display examples without displaying the confirmation support view according to the first to second display examples. In the latter case, for example, the presentation unit 35 displays the confirmation support view according to the third to fifth display examples for each target object position which the difference determination unit 34 determines as the confirmation-needed target object position Ptag without receiving the designation of the correction target on the confirmation support view according to the first to second display examples.

[Process Flow]

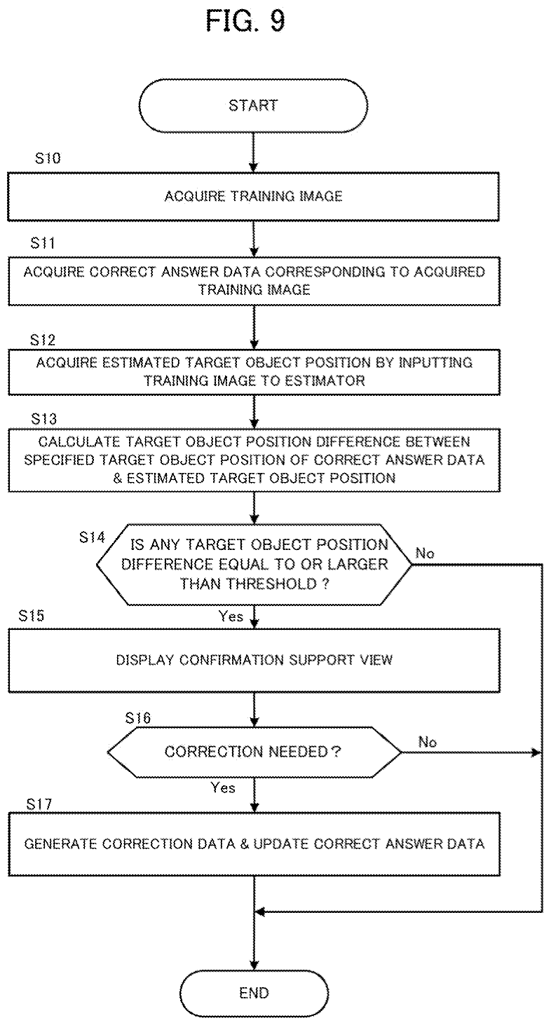

FIG. 9 is a flowchart illustrating a processing procedure executed by the information presentation device 10. The information presentation device 10 executes processing of the flowchart shown in FIG. 9 for each training image corresponding to the correct answer data subjected to confirmation.

First, the training image acquisition unit 31 of the information presentation device 10 acquires a training image corresponding to the correct answer data to be confirmed from the training image storage unit 21 (Step S10). The specified target object position acquisition unit 33 acquires correct answer data corresponding to the acquired training image from the correct answer data storage unit 23 (step S11). Next, the estimated target object position acquisition unit 32 acquires, by inputting the training image to the estimator configured by the estimator information stored in the estimator information storage unit 22, the estimated target object position Pe (step S12).

Then, the difference determination unit 34 calculates the target object position difference dP between the specified target object position Ps indicated by the correct answer data obtained at step S11 and the estimated target object position Pe obtained at step S12 (step S13). In this case, as described in the section of “(3) Calculation of Target Object Position Difference”, the difference determination unit 34 first determines the correspondence between the specified target object position Ps and the estimated target object position Pe, and then calculates the target object position difference dP with respect to the combination of the specified target object position Ps and the corresponding estimated target object position Pe. Further, the difference determination unit 34 determines the target object position difference dP to be used at step S14 with respect to the specified target object position Ps or the estimated target object position Pe which do not have the correspondence to each other so that the target object position difference dP is a predetermined value equal to or larger than the threshold dPth.

Next, the difference determination unit 34 determines whether or not the target object position difference dP that is equal to or larger than the threshold dPth is present (step S14). Then, when the target object position difference dP that is equal to or larger than the threshold dPth is present (step S14; Yes), the presentation unit 35 displays a confirmation support view relating to the specified target object position Ps or/and the estimated target object position Pe used in the calculation of the target object position difference dP (step S15). Thereby, the information presentation device 10 can make the confirmer suitably confirm the target object position which needs confirmation in the target training image.

Then, the presentation unit 35 determines whether or not correction of the specified target object position Ps (including addition or deletion of the specified target object position Ps) is necessary (step S16). In this case, the presentation unit 35 determines whether or not to correct the specified target object position Ps based on the input data accepted on the confirmation support view by the input unit 15. Then, if the correction of the specified target object position Ps is necessary (step S16; Yes), the correction unit 36 generates correction data in accordance with the input data inputted on the confirmation support view and updates the correct answer data stored in the correct answer data storage unit 23 by use of the correction data after the correction (step S17). Then, the information presentation device 10 ends the processing of the flowchart. Further, when the correction of the specified target object position Ps is not necessary (step S16; No), the information presentation device 10 ends the processing of the flowchart.

Here, a supplementary description will be given of the effect according to the present example embodiment. It is common that the correct answer data generated by annotation work is adopted as the training data as it is as reliable data. Therefore, it is difficult to discover it when a mistake occurred in the annotation work of the correct answer or when the annotation was performed great differently from the standard. Then, when the learning is performed using the correct answer data generated based on the incorrect annotation as the training data, it causes the deterioration of the image recognition accuracy of the generated estimator.

In view of the above, the information presentation device 10 presents information for prompting the user to confirm the target object position on the basis of the difference between the specified target object position Ps generated by the annotation operation and the estimated target object position Pe by the estimator. Thereby, the information presentation device 10 suitably prompts the user to confirm the correct answer data that may have been incorrectly generated, and lets the confirmer recognize the presence of improper correct answer data. Accordingly, the information presentation device 10 suitably suppress the oversight of the presence of the correct answer data in which a mistake occurs in the annotation operation of the correct answer or the correct answer data generated by annotation performed great differently from the standard.

[Modification]

Next, a description will be given of a preferred modification to the example embodiment described above. Modifications described below may be applied to the example embodiments described above in arbitrary combination.

(First Modification)

The information presentation device 10 may further execute a process of learning the estimator using the correct answer data corrected by the correction unit 36.

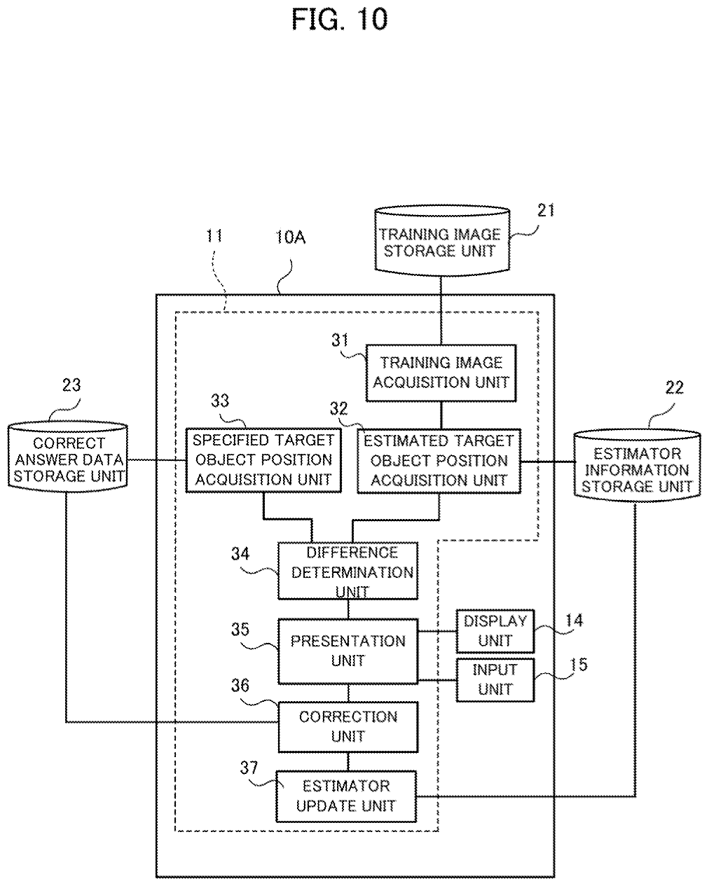

FIG. 10 is a functional block diagram of an information presentation device 10A according to a first modification. The information presentation device 10A according to the first modification differs from the information presentation device 10 in that the estimator is learned using the correct answer data corrected by the correction unit 36.

The processor 11 of the information presentation device 10A according to the first modification includes an estimator update unit 37. The estimator update unit 37 performs learning of the estimator based on the estimator information stored in the estimator information storage unit 22 by using the set of correct answer data corrected by the correction unit 36 and the corresponding training image. Then, the estimator update unit 37 stores the estimator information to configure the learned estimator in the estimator information storage unit 22.

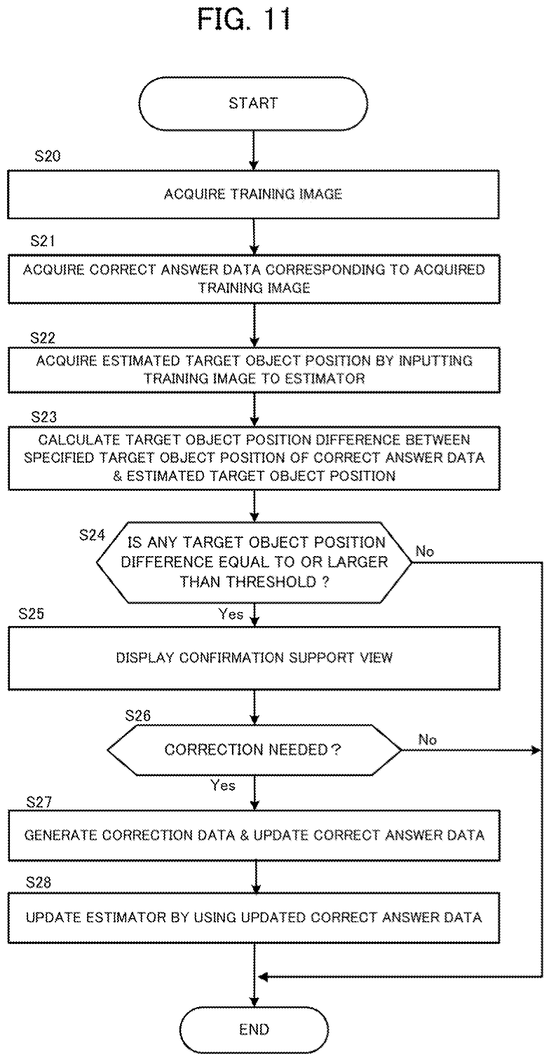

FIG. 11 is a flowchart illustrating a processing procedure of the information presentation device 10A according to the first modification. Since step S20 to step S27 are the same as step S10 to step S17 in the flowchart of FIG. 9, description thereof will be omitted.

The information presentation device 10A updates the estimator to be used at step S22 by using the updated correct answer data after updating the correct answer data at step S27 (step S28). In this case, the information presentation device 10A further executes the learning of the estimator to be used at step S22 by using the set of the correct answer data generated at step S27 and the corresponding training image. Then, the information presentation device 10A updates the estimator information storage unit 22 by the estimator information corresponding to the learned estimator. Then, the information presentation device 10A terminates the processing of the flow chart. Instead of executing step S28 every time executing step S27, the information presentation device 10A may perform the update process of the estimator at step S28 when there is an update of correct answer data fora plurality of training images (i.e., when step S27 is executed a predetermined number of times).

Thus, according to this modification, the information presentation device 10A suitably improves the estimation accuracy of the estimator by learning the estimator based on the corrected correct answer data. Thus, the information presentation device 10A improves the accuracy of the estimated target object position Pe to be used when determining whether or not the confirmation by the confirmer is necessary thereafter, and can more accurately present the target object position that needs to be confirmed by the confirmer.

At step S28 of FIG. 11, instead of performing the learning of the estimator by using the set of the updated correct answer data and the corresponding training image, the information presentation device 10A may perform the learning of the estimator by using the set of the correct answer data, which includes the specified target object position Ps whose target object position difference dP is smaller than the predetermined threshold value (also referred to as the “third threshold value”), and the corresponding training image. Namely, in this case, at step S28, the information presentation device 10A updates the estimator by using a set of correct answer data including the specified target object position Ps whose target object position difference dP calculated at step S23 is smaller than the third threshold value and the corresponding training image.

In this case, the third threshold described above is set to the same value as the threshold dPth or a value smaller than the threshold dPth. Then, the information presentation device 10A stores the estimator information corresponding to the learned estimator in the estimator information storage unit 22. In this way, by performing the learning of the estimator by using the correct answer data including the specified target object position Ps which is unlikely to have errors in the annotation operation, it can be expected that the accuracy of the estimated target object position Pe by the estimator is preferably increased.

(Second Modification)

When the classification of the object corresponding to the target object estimated by the estimator differs from the classification of the object according to the correct answer data, the information presentation device 10 may consider that the target object position difference dP is equal to or higher than the threshold value dPth and regard the corresponding target object position as the confirmation-needed target object position Ptag.

In this case, the estimator based on the estimator information stored in the estimator information storage unit 22 is generated, for example, by training a learning model that outputs, when an input image is inputted thereto, the estimated target object position Pe and the estimated result regarding the classification of the object corresponding to the target object. Further, the correct answer data stored in the correct answer data storage unit 23 includes the classification information relating to the target object corresponding to each specified target object position Ps.

Then, when determining the correspondence between the specified target object position Ps and the estimated target object position Pe at the time of calculating the target object position difference dP, the information presentation device 10 compares the classification information outputted by the estimator with the classification information stored in the correct answer data storage unit 23 in association with the above specified target object position Ps. When these classification information indicates different classification, the information presentation device 10 considers that the target object position difference dP is a threshold dPth regardless of the comparison result with the specified target object position Ps and the corresponding estimated target object position Pe. In this case, the information presentation device 10 regards the target object position as the confirmation-needed target object position Ptag and displays a confirmation support view for confirming the classification information.

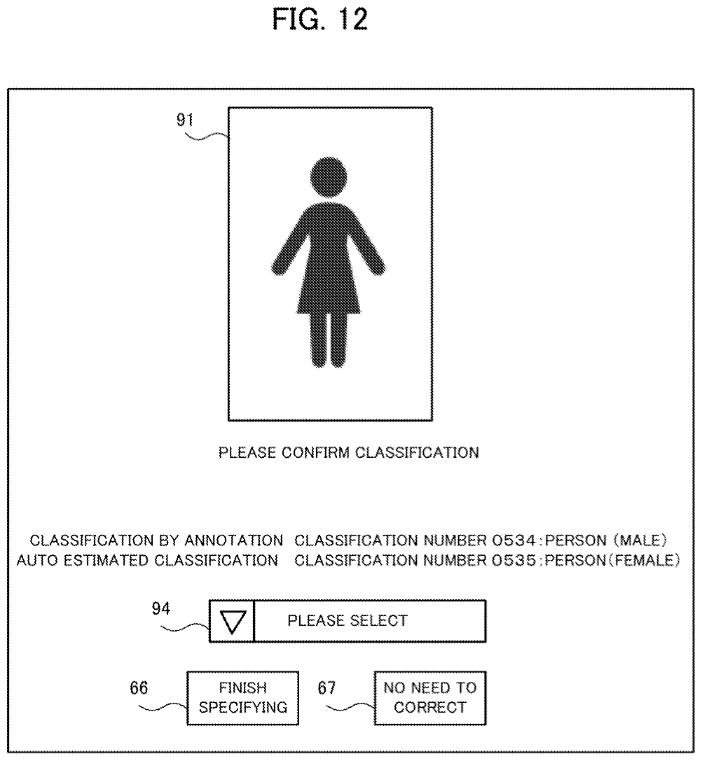

FIG. 12 is a sixth display example of the confirmation support view. The confirmation support view shown in FIG. 12 is displayed when there is a difference between the classification information estimated as the classification of the target object indicated by the estimated target object position Pe and the classification information stored in the correct answer data storage unit 23 in association with the specified target object position Ps.

In FIG. 12, the presentation unit 35 of the information presentation device 10 displays on the confirmation support view a cut-out image 91 displaying the target object position, a classification selection field 94, a specifying finish button 66 and a correction no-need button 67. In addition, the presentation unit 35 displays on the confirmation support view a sentence indicating that the classification of the target object displayed on the cut-out image 91 should be confirmed, and also displays “CLASSIFICATION BY ANNOTATION” (here, the classification number 534 of persons (male)) indicating the classification based on the correct answer data and “AUTO ESTIMATED CLASSIFICATION” (here, classification number 535 of persons (female)) indicating the classification based on the estimation result of the estimator.

In this case, the confirmer determines whether or not to correct the classification information of the correct answer data with reference to the confirmation support view. If the confirmer determines that it is unnecessary to correct the classification information, the confirmer selects the correction no-need button 67. When detecting that the correction no-need button 67 is selected, the presentation unit 35 determines that correction of the correct answer data is not necessary. Further, if the confirmer determines that the correction of the classification information of the correct answer data is necessary, the confirmer selects the correct classification in the classification selection field 94 and then selects the specifying finish button 66. Here, as an example, the classification selection field 94 is an input field according to a pull-down menu type, and it is possible for the classification selection field 94 to accept the selection of an arbitrary classification registered in advance. In such a case that it is necessary to specify a plurality of classifications such as large classification, medium classification, and small classification, multiple classification selection fields 94 may be provided according to the number of classifications that need to be specified. When detecting that the specifying finish button 66 is selected, the presentation unit 35 supplies the classification information indicating the classification selected in the classification selection field 94 to the correction unit 36. Then, the correction unit 36 generates correction data based on the classification information indicating the classification selected in the classification selection field 94, and updates the correct answer data storage unit 23 by the generated correction data. Thus, the classification information of the correct answer data corresponding to the target object position displayed on the confirmation support view is set to the classification information specified in the classification selection field 94.

Thus, according to the present modification, the information presentation device 10 can suitably let the confirmer confirm and correct the classification information regarding the target object position where it is likely that the correction of the classification information is necessary.

(Third Modification)

When the number of the specified target object positions Ps and the number of the estimated target object positions Pe in the target training image do not match, the information presentation device 10 may determine that the target object position difference dP corresponding to at least one of the specified target object positions Ps or the estimated target object positions Pe in the target training image is equal to or larger than the threshold dPth. Namely, when the number of the specified target object position Ps in the training image of the target object does not match the number of the estimated target object position Pe, the information presentation device 10 may determine that the confirmation-need target object position Ptag exists in the target training image. In this case, for example, the information presentation device 10 displays the target training image on the confirmation support view and receives an input for specifying the target object position subjected to correction according to the first display example shown in FIG. 4 or the second display example shown in FIG. 5.

Thus, according to this modification, the information presentation device 10 can suitably determine the necessity of the display of information for prompting confirmation to the confirmer for each training image based on the number of the specified target object position Ps and the number of the estimated target object position Pe.

(Fourth Modification)

The information presentation device 10 may not have the difference determination unit 34 and the correction unit 36.

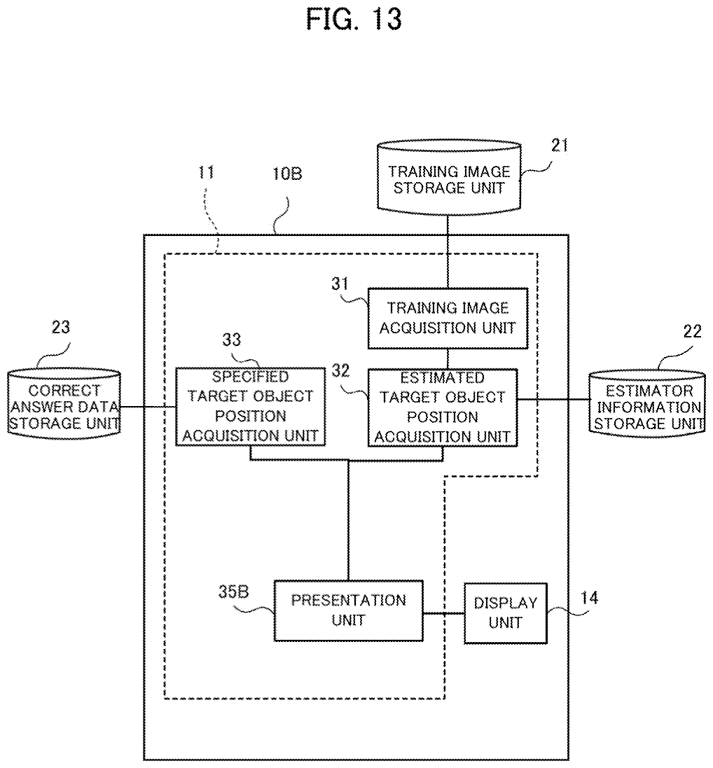

FIG. 13 is a functional block diagram of an information presentation device 10B according to a fourth modification. The processor 11 of the information presentation device 10B functionally includes the training image acquisition unit 31, the estimated target object position acquisition unit 32, the specified target object position acquisition unit 33, and a presentation unit 35B. The training image acquisition unit 31, the estimated target object position acquisition unit 32, and the specified target object position acquisition unit 33 perform the same process as the above-described example embodiment described with reference to FIG. 2.

The presentation unit 35B performs processing corresponding to the difference determination unit 34 and the presentation unit 35 shown in FIG. 2. Specifically, the presentation unit 35B calculates the target object position difference dP based on the estimated target object position Pe supplied from the estimated target object position acquisition unit 32 and the specified target object position Ps supplied from the specified target object position acquisition unit 33. Then, on the basis of the target object position difference dP, the presentation unit 35B displays information for prompting the user (the confirmer) to confirm the target object position that is an area or coordinates of the target object existing in the training image.

Even according to this mode, the information presentation device 10B can suitably let the confirmer confirm the necessity of correcting the correct answer data. In a case where the confirmer determines, on the basis of the information presented by the information presentation device 10B, that the correction of the correct answer data is required, for example, the confirmer updates the correct answer data storage unit 23 by communicating with the storage device 20 using another device used in the annotation operation of the correct answer.

The whole or a part of the example embodiments described above (including modifications, the same applies hereinafter) can be described as, but not limited to, the following Supplementary Notes.

[Supplementary Note 1]

An information presentation method comprising:

acquiring a training image to be used for a learning;

acquiring an estimated target object position that is a position estimated as an area or coordinates where a target object exists in the training image;

acquiring a specified target object position that is a position specified as the area or the coordinates where the target object exists in the training image; and

presenting information for prompting a user to confirm the area or the coordinates where the target object exists based on a difference between the estimated target object position and the specified target object position.

[Supplementary Note 2]

2. The information presentation method according to Supplementary Note 1, further comprising

determining a correspondence between the estimated target object position and the specified target object position,

wherein the information presentation method presents the information based on the difference between the estimated target object position and the specified target object position which have the correspondence to each other.

[Supplementary Note 3]

The information presentation method according to Supplementary Note 1 or 2,

wherein the information presentation method displays, as the information, a character or a graphic together with the training image or a part of the training image which illustrates the area or the coordinates where the target object exists, the character or the graphic indicating a guide for correcting the specified target object position.

[Supplementary Note 4]

The information presentation method according to Supplementary Note 1 or 2, further comprising

acquiring correction data relating to the specified target object position.

[Supplementary Note 5]

The information presentation method according to Supplementary Note 4,

wherein the correction data includes at least one of:

information relating to the corrected specified target object position indicative of a corrected area whose position or size is corrected;

information relating to the corrected specified target object position indicative of corrected coordinates;

information relating to a corrected classification of the target object; or

information which instructs to delete information relating to the specified target object position in a case that the specified target object position indicates a position where the target object does not exist.

[Supplementary Note 6]

6. The information presentation method according to any one of Supplementary Notes 1 to 5,

wherein, in a case of determining that there is the difference between the estimated target object position and the specified target object position, the information presentation method prompts the user to confirm the area or the coordinates where the target object exists.

[Supplementary Note 7]

The information presentation method according to Supplementary Note 6,

wherein the information presentation method determines that there is the difference between the estimated target object position and the specified target object position if at least one of:

a condition that there is no specified target object position corresponding to the estimated target object position;

a condition that there is no estimated target object position corresponding to the specified target object position; or

a condition that there is a predetermined degree of the difference between an area indicated by the specified target object position and an area indicated by the estimated target object position is satisfied.

[Supplementary Note 8]

The information presentation method according to Supplementary Note 6,

wherein the information presentation method determines that there is the difference between the estimated target object position and the specified target object position

in a case where there is difference between the number of the estimated target object position in the training image and the number of the specified target object position in the training image or

in a case where a classification of the target object corresponding to the estimated target object position and a classification of the target object corresponding to the specified target object position.

[Supplementary Note 9]

The information presentation method according to any one of Supplementary Notes 1 to 8,

wherein, in a case of determining that there is the difference between the estimated target object position and the specified target object position, the information presentation method presents, as the information, the training image or a part of the training image in which an area including at least one of the estimated target object position or the specified target object position is highlighted.

[Supplementary Note 10]

The information presentation method according to any one of Supplementary Notes 1 to 9,

wherein, in a case of determining that there is the difference between the estimated target object position and the specified target object position, the information presentation method present, as the information, a cut-out image that is an area including at least one of the estimated target object position or the specified target object position cut out from the training image.

[Supplementary Note 11]

The information presentation method according to any one of Supplementary Notes 1 to 10, further comprising

learning an estimator by using the training image and the specified target object position in a case of determining that there is no difference between the estimated target object position and the specified target object position, the estimator being configured to output the estimated target object position.

[Supplementary Note 12]

The information presentation method according to any one of Supplementary Notes 1 to 11, further comprising

learning an estimator by using the training image and correction data in a case of acquiring the correction data relating to the specified target object position.

[Supplementary Note 13]

An information presentation device comprising:

a training image acquisition unit configured to acquire a training image to be used for a learning;

an estimated target object position acquisition unit configured to acquire an estimated target object position that is a position estimated as an area or coordinates where a target object exists in the training image;

a specified target object position acquisition unit configured to acquire a specified target object position that is a position specified as the area or the coordinates where the target object exists in the training image; and

a presentation unit configured to present information for prompting a user to confirm the area or the coordinates where the target object exists based on a difference between the estimated target object position and the specified target object position.

[Supplementary Note 14]

A program executed by a computer, the program causing the computer to function as:

a training image acquisition unit configured to acquire a training image to be used for a learning;

an estimated target object position acquisition unit configured to acquire an estimated target object position that is a position estimated as an area or coordinates where a target object exists in the training image;

a specified target object position acquisition unit configured to acquire a specified target object position that is a position specified as the area or the coordinates where the target object exists in the training image; and a presentation unit configured to present information for prompting a user to confirm the area or the coordinates where the target object exists based on a difference between the estimated target object position and the specified target object position.

While the invention has been particularly shown and described with reference to example embodiments thereof, the invention is not limited to these embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent Literatures mentioned in this specification are incorporated by reference in its entirety.

### DESCRIPTION OF REFERENCE NUMERALS

10, 10A, 10B Information presentation device
11 Processor
12 Memory
13 Interface
14 Display unit
15 Input unit
16 Sound output unit
20 Storage device
21 Training image storage unit
22 Estimator information storage unit
23 Correct answer data storage unit
100 Information presentation system

What is claimed is:

1. An information presentation method comprising:
acquiring a training image to be used for a learning;
acquiring an estimated target object position that is a position estimated as an area or coordinates where a target object exists in the training image;
acquiring a specified target object position that is a position specified as the area or the coordinates where the target object exists in the training image; and
presenting information for prompting a user to confirm the area or the coordinates where the target object exists based on a difference between the estimated target object position and the specified target object position.

2. The information presentation method according to claim 1, further comprising
determining a correspondence between the estimated target object position and the specified target object position,
wherein the information presentation method presents the information based on the difference between the estimated target object position and the specified target object position which have the correspondence to each other.

3. The information presentation method according to claim 1,
wherein the information presentation method displays, as the information, a character or a graphic together with the training image or a part of the training image which illustrates the area or the coordinates where the target object exists, the character or the graphic indicating a guide for correcting the specified target object position.

4. The information presentation method according to claim 1, further comprising
acquiring correction data relating to the specified target object position.

5. The information presentation method according to claim 4,
wherein the correction data includes at least one of:
information relating to the corrected specified target object position indicative of a corrected area whose position or size is corrected;
information relating to the corrected specified target object position indicative of corrected coordinates;
information relating to a corrected classification of the target object; or
information which instructs to delete information relating to the specified target object position in a case that the specified target object position indicates a position where the target object does not exist.

6. The information presentation method according to claim 1,
wherein, in a case of determining that there is the difference between the estimated target object position and the specified target object position, the information presentation method prompts the user to confirm the area or the coordinates where the target object exists.

7. The information presentation method according to claim 6,
wherein the information presentation method determines that there is the difference between the estimated target object position and the specified target object position if at least one of:
a condition that there is no specified target object position corresponding to the estimated target object position;
a condition that there is no estimated target object position corresponding to the specified target object position;
a condition that there is a predetermined degree of the difference between an area indicated by the specified target object position and an area indicated by the estimated target object position; or
a condition that there is a predetermined degree of the difference between coordinates indicated by the specified target object position and coordinates indicated by the estimated target object position is satisfied.

8. The information presentation method according to claim 6,
wherein the information presentation method determines that there is the difference between the estimated target object position and the specified target object position
in a case where there is difference between the number of the estimated target object position in the training image and the number of the specified target object position in the training image or
in a case where a classification of the target object corresponding to the estimated target object position and a classification of the target object corresponding to the specified target object position.

9. The information presentation method according to claim 1,
wherein, in a case of determining that there is the difference between the estimated target object position and the specified target object position, the information presentation method presents, as the information, the training image or a part of the training image in which an area including at least one of the estimated target object position or the specified target object position is highlighted.

10. The information presentation method according to claim 1,
wherein, in a case of determining that there is the difference between the estimated target object position and the specified target object position, the information presentation method presents, as the information, a cut-out image that is an area including at least one of the estimated target object position or the specified target object position cut out from the training image.

11. The information presentation method according to claim 1, further comprising
learning an estimator by using the training image and the specified target object position in a case of determining that there is no difference between the estimated target object position and the specified target object position, the estimator being configured to output the estimated target object position.

12. The information presentation method according to claim 1, further comprising
learning an estimator by using the training image and correction data in a case of acquiring the correction data relating to the specified target object position.

13. An information presentation device comprising a processor configured to:
acquire a training image to be used for a learning;
acquire an estimated target object position that is a position estimated as an area or coordinates where a target object exists in the training image;
acquire a specified target object position that is a position specified as the area or the coordinates where the target object exists in the training image; and
present information for prompting a user to confirm the area or the coordinates where the target object exists based on a difference between the estimated target object position and the specified target object position.

14. A non-transitory computer readable medium including a program executed by a computer, the program causing the computer to:
acquire a training image to be used for a learning;
acquire an estimated target object position that is a position estimated as an area or coordinates where a target object exists in the training image;
acquire a specified target object position that is a position specified as the area or the coordinates where the target object exists in the training image; and
present information for prompting a user to confirm the area or the coordinates where the target object exists based on a difference between the estimated target object position and the specified target object position.

15. The information presentation device according to claim 13,
wherein the processor is further configured to determine a correspondence between the estimated target object position and the specified target object position, and
wherein the processor is configured to present the information based on the difference between the estimated target object position and the specified target object position which have the correspondence to each other.

16. The information presentation device according to claim 13,
wherein the processor is configured to display, as the information, a character or a graphic together with the training image or a part of the training image which illustrates the area or the coordinates where the target object exists, the character or the graphic indicating a guide for correcting the specified target object position.

17. The information presentation device according to claim 13,
wherein the processor is further configured to acquire correction data relating to the specified target object position.

18. The information presentation device according to claim 17,
wherein the correction data includes at least one of:
information relating to the corrected specified target object position indicative of a corrected area whose position or size is corrected;
information relating to the corrected specified target object position indicative of corrected coordinates;
information relating to a corrected classification of the target object; or
information which instructs to delete information relating to the specified target object position in a case that the specified target object position indicates a position where the target object does not exist.

19. The information presentation device according to claim 13,
wherein, in a case of determining that there is the difference between the estimated target object position and the specified target object position, the processor is configured to prompt the user to confirm the area or the coordinates where the target object exists.

20. The information presentation device according to claim 19,
wherein the processor is configured to determine that there is the difference between the estimated target object position and the specified target object position if at least one of:
a condition that there is no specified target object position corresponding to the estimated target object position;
a condition that there is no estimated target object position corresponding to the specified target object position;
a condition that there is a predetermined degree of the difference between an area indicated by the specified target object position and an area indicated by the estimated target object position; or
a condition that there is a predetermined degree of the difference between coordinates indicated by the specified target object position and coordinates indicated by the estimated target object position is satisfied.
